(19) United States
(12) Patent Application Publication
(10) Pub. No.: US 2015/0170272 A1
(43) Pub. Date: Jun. 18, 2015

(54) Offset Options

(71) Applicant: Chicago Mercantile Exchange Inc., Chicago, IL (US)

(72) Inventors: Edward Gogol, Skokie, IL (US); John Labuszewski, Westmont, IL (US); David Bixby, Arlington Heights, IL (US); Charles Piszczor, West Dundee, IL (US); John Nyhoff, Darien, IL (US)

(73) Assignee: Chicago Mercantile Exchange Inc., Chicago, IL (US)

(21) Appl. No.: 14/105,734

(22) Filed: Dec. 13, 2013

(51) Int. Cl. G06Q 40/04

(52) U.S. Cl. CPC G06Q 40/04

(57) ABSTRACT

An offset option class corresponds to an optioned transaction class and to an offset value. After execution of offset options of the offset option class, a current value for a transaction of the optioned transaction class is determined. Exercised option data is stored in response to data indicating exercise of offset options of the offset option class. Exercised option data corresponding to an offset option holder interest indicates a first set of one or more positions in a transaction of the optioned transaction class, the first set of one or more positions having a positive net value based on the offset value. Exercised option data corresponding to an offset option grantor interest indicates a second set of one or more positions in a transaction of the optioned transaction class, the second set of one or more positions having a negative net value based on the offset value.

### BACKGROUND

An option is an undertaking by which a first party has the right, but not the obligation, to require a second party to enter into an optioned transaction at some future time. That second party has an obligation to enter into that optioned transaction if the first party exercises its right. The first party may be called the “receiver,” “buyer,” “holder” or “bearer” of the option. The second party may be called the “grantor,” “seller” or “writer” of the option. An option grantor will often receive a payment or some other value in return for granting that option. Similarly, an option buyer often makes some payment or otherwise provides value in return for receiving the option.

Optioned transactions can take many forms. For example, an optioned transaction may be the entry into a futures contract or some other type of subsequent agreement. A holder of an option in this example may have the right to require the option grantor to sell (or buy) a particular type of futures contract, at a predefined future time, at a predefined price. That predefined price is often called the “strike” price. Conventionally, the strike price for such an option is set as of the time the option is entered (or executed) by the holder and the grantor.

### SUMMARY

This Summary is provided to introduce a selection of concepts in a simplified form that are further described below in the Detailed Description. This Summary is not intended to identify key or essential features of the invention.

In at least some embodiments, all options of an offset option class correspond to an optioned transaction class and to an offset value. First and second order data are received, the first order data indicating a buy order for an offset option of the offset option class and the second order data indicating a sell order for an offset option of the offset option class. First and second execution data are subsequently stored. The first execution data corresponds to the buy order and indicates a holder interest in an offset option of the offset option class. The second execution data corresponds to the sell order and indicates a grantor interest in an offset option of the offset option class. A determination of a current value for a transaction of the optioned transaction class is made. The determination is made at a time after the storing of the first and second execution data. First and second exercised option data is then stored in response to data indicating exercise of offset options of the offset option class. The first exercised option data corresponds to the holder interest and indicates a first set of one or more positions in a transaction of the optioned transaction class, the first set of one or more positions having a positive net value based on the offset value. The second exercised option data corresponds to the grantor interest and indicates a second set of one or more positions in a transaction of the optioned transaction class, the second set of one or more positions having a negative net value based on the offset value.

Embodiments include, without limitation, methods for processing data associated with offset options, computer systems configured to perform such methods, and computer-readable media storing instructions that, when executed, cause a computer system to perform such methods.

### BRIEF DESCRIPTION OF THE DRAWINGS

Some embodiments are illustrated by way of example, and not by way of limitation, in the figures of the accompanying drawings and in which like reference numerals refer to similar elements.

FIG. 1 shows an exemplary trading network environment for implementing trading systems and methods according to at least some embodiments.

FIGS. 2A through 2F are block diagrams showing operations performed by an exchange computer system in connection with offset options according to some embodiments.

FIG. 3 is a flow chart showing steps performed in methods according to at least some embodiments.

### DETAILED DESCRIPTION

In the following description of various embodiments, reference is made to the accompanying drawings, which form a part hereof, and in which various embodiments are shown by way of illustration. It is to be understood that there are other embodiments and that structural and functional modifications may be made. Embodiments of the present invention may take physical form in certain parts and steps, examples of which will be described in detail in the following description and illustrated in the accompanying drawings that form a part hereof

Various embodiments may comprise a method, a computer system, and/or a computer program product. Accordingly, one or more aspects of one or more of such embodiments may take the form of an entirely hardware embodiment, an entirely software embodiment and/or an embodiment combining software and hardware aspects. Furthermore, such aspects may take the form of a computer program product stored by one or more non-transitory computer-readable storage media having computer-readable program code, or instructions, embodied in or on the storage media. The term “computer-readable medium” or “computer-readable storage medium” as used herein includes not only a single medium or single type of medium, but also a combination of one or more media and/or types of media. Such a non-transitory computer-readable medium may store computer-readable instructions (e.g., software) and/or computer-readable data (i.e., information that may or may not be executable). Any suitable computer readable media may be utilized, including various types of non-transitory computer readable storage media such as hard disks, CD-ROMs, optical storage devices, magnetic storage devices, FLASH memory and/or any combination thereof. The term “computer-readable medium” or “computer-readable storage medium” could also include an integrated circuit or other device having hard-coded instructions (e.g., logic gates) that configure the device to perform one or more operations.

Aspects of method steps described in connection with one or more embodiments may be executed by one or more processors associated with a computer system (such as exchange computer system 100 described below). As used herein, a “computer system” could be a single computer or could comprise multiple computers. When a computer system comprising multiple computers performs a method, various steps could be performed by different ones of those multiple computers. Processors of a computer system may execute computer-executable instructions stored on non-transitory computer-readable media. Embodiments may also be practiced in a computer system forming a distributed computing environment, with tasks performed by remote processing devices that are linked through a communications network. In a distributed computing environment, program modules may be located in both local and remote computer storage media including memory storage devices.

### Exemplary Operating Environment

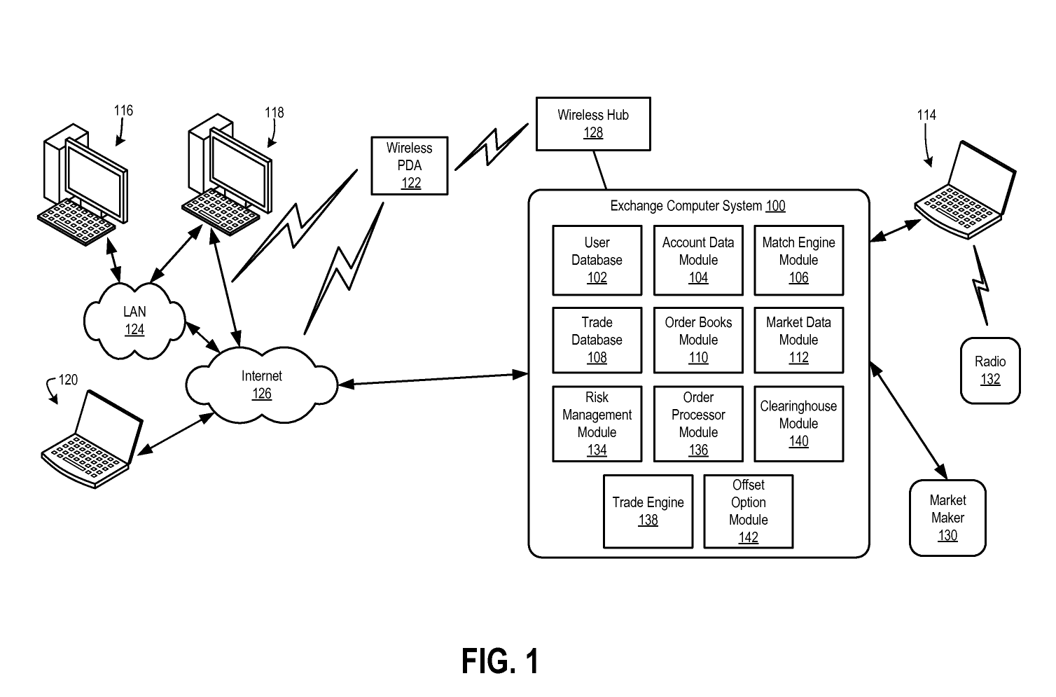

Aspects of at least some embodiments can be implemented with computer systems and computer networks that allow users to communicate trading information. An exemplary trading network environment for implementing systems and methods according to at least some embodiments is shown in FIG. 1. The implemented systems and methods can include systems and methods, such as are described herein, that facilitate data processing and other activities associated with offset options.

Computer system 100 can be operated by an exchange (e.g., a financial product exchange or other type of exchange) and configured to perform operations of the exchange for, e.g., trading and otherwise processing various financial products. Financial products of the exchange may include, without limitation, futures contracts, options on futures contracts (“futures contract options”), other types of options, and other types of derivative contracts. Financial products traded or otherwise processed by the exchange may also include over-the-counter (OTC) products such as OTC forwards, OTC options, etc. In at least some embodiments, and as explained in more detail below, financial products traded and/or otherwise processed through exchange computer system 100 include offset options such as those described herein.

Computer system 100 receives orders for financial products, matches orders to execute trades, transmits market data related to orders and trades to users, and performs other operations associated with an exchange. Exchange computer system 100 may be implemented with one or more mainframe, desktop or other computers. In one embodiment, a computer device uses a 64-bit processor. A user database 102 includes information identifying traders and other users of exchange computer system 100. Data may include user names and passwords. An account data module 104 may process account information that may be used during trades. A match engine module 106 is included to match prices and other parameters of bid and offer orders. Match engine module 106 may be implemented with software that executes one or more algorithms for matching bids and offers.

A trade database 108 may be included to store information identifying trades and descriptions of trades. In particular, a trade database may store information identifying the time that a trade took place and the contract price. An order book module 110 may be included to store prices and other data for bid and offer orders, and/or to compute (or otherwise determine) current bid and offer prices. A market data module 112 may be included to collect market data, e.g., data regarding current bids and offers for futures contracts, futures contract options and other derivative products. Module 112 may also prepare the collected market data for transmission to users. A risk management module 134 may be included to compute and determine a user's risk utilization in relation to the user's defined risk thresholds. An order processor module 136 may be included to decompose delta based and bulk order types for further processing by order book module 110 and match engine module 106.

A clearinghouse module 140 may be included as part of exchange computer system 100 and configured to carry out operations of a clearinghouse of the exchange that operates computer system 100. Module 140 may receive data from and/or transmit data to trade database 108 and/or other modules of computer system 100, including offset option module 142, regarding trades of futures contracts, futures contracts options, and other financial products traded through the exchange that operates system 100. Clearinghouse module 140 may facilitate the exchange (or a clearinghouse of the exchange) acting as one of the parties to every traded contract or other product. For example, computer system 100 may match an offer by party A to sell a futures contract or another exchange-traded financial product with a bid by party B to purchase a like exchange-traded financial product. Module 140 may then create an exchange-traded financial product between party A and the exchange clearinghouse and a second exchange-traded financial product between the exchange clearinghouse and party B. Module 140 may similarly create offsetting contracts when creating contracts as a result of an option exercise. Module 140 may also be configured to perform other clearinghouse operations. As a further example, module 140 may maintain margin data with regard to clearing members and/or trading customers. As part of such margin-related operations, module 140 may store and maintain data regarding the values of various contracts and other instruments, determine mark-to-market and final settlement amounts, confirm receipt and/or payment of amounts due from margin accounts, confirm satisfaction of delivery and other final settlement obligations, etc.

Offset option module 142 generates, stores and processes data regarding offset options. Various operations performed by offset option module 142 in at least some embodiments are further described below. As also discussed below, operations associated with offset options may also and/or alternatively be performed by other modules of system 100.

Each of modules 102 through 142 could be implemented as separate software components executing within a single computer, separate hardware components (e.g., dedicated hardware devices) in a single computer, separate computers in a networked computer system, or any combination thereof (e.g., different computers in a networked system may execute software modules corresponding more than one of modules 102-142). When one or more of modules 102 through 142 are implemented as separate computers in a networked environment, those computers may be part of a local area network, a wide area network, and/or multiple interconnected local and/or wide area networks.

Exchange computer system 100 may also communicate in a variety of ways with devices that may be logically distinct from computer system 100. For example, computer device 114 is shown directly connected to exchange computer system 100. Exchange computer system 100 and computer device 114 may be connected via a T1 line, a common local area network (LAN) or other mechanism for connecting computer devices. Computer device 114 is shown connected to a radio 132. The user of radio 132 may be a trader or exchange employee. The radio user may transmit orders or other information to a user of computer device 114. The user of computer device 114 may then transmit the trade or other information to exchange computer system 100.

Computer devices 116 and 118 are coupled to a LAN 124 and may communicate with exchange computer system 100 via LAN 124. LAN 124 may implement one or more of the well-known LAN topologies and may use a variety of different protocols, such as Ethernet. Computers 116 and 118 may communicate with each other and other computers and devices connected to LAN 124. Computers and other devices may be connected to LAN 124 via twisted pair wires, coaxial cable, fiber optics, radio links or other media.

A wireless personal digital assistant device (PDA) 122 may communicate with LAN 124 or the Internet 126 via radio waves. PDA 122 may also communicate with exchange computer system 100 via a conventional wireless hub 128. As used herein, a PDA includes mobile telephones and other wireless devices that communicate with a network via radio waves.

FIG. 1 also shows LAN 124 connected to the Internet 126. LAN 124 may include a router to connect LAN 124 to the Internet 126. Computer device 120 is shown connected directly to the Internet 126. The connection may be via a modem, DSL line, satellite dish or any other device for connecting a computer device to the Internet. Computers 116, 118 and 120 may communicate with each other via the Internet 126 and/or LAN 124.

One or more market makers 130 may maintain a market by providing constant bid and offer prices for a derivative or security to exchange computer system 100. Exchange computer system 100 may also include trade engine 138. Trade engine 138 may, e.g., receive incoming communications from various channel partners and route those communications to one or more other modules of exchange computer system 100.

One skilled in the art will appreciate that numerous additional computers and systems may be coupled to exchange computer system 100. Such computers and systems may include, without limitation, additional clearing systems, regulatory systems and fee systems.

The operations of computer devices and systems shown in FIG. 1 may be controlled by computer-executable instructions stored on non-transitory computer-readable media. For example, computer device 116 may include computer-executable instructions for receiving market data from exchange computer system 100 and displaying that information to a user. As another example, module 142 and/or other modules of exchange computer system 100 may include computer-executable instructions for performing herein-described operations associated with offset options.

Of course, numerous additional servers, computers, handheld devices, personal digital assistants, telephones and other devices may also be connected to exchange computer system 100. Moreover, one skilled in the art will appreciate that the topology shown in FIG. 1 is merely an example and that the components shown in FIG. 1 may be connected by numerous alternative topologies.

### Exemplary Embodiments

In at least some embodiments, exchange computer system 100 (or “system 100”) receives, stores, generates and/or otherwise processes data associated with offset options and optioned transactions as described herein. Throughout this description, “offset option” is distinguished from “offset option class.” “Offset option” refers to a contract that is created, or “executed,” when two parties have agreed to assume responsibilities of offset option holder and offset option grantor. The parties may reach that agreement bilaterally or multilaterally through an exchange. “Offset option class” (or “class of offset options”) refers to a category of offset options that have the same terms. Offset option execution is also distinct from offset option exercise. Offset option execution refers to the creation of an offset option contract. Offset option exercise refers to the exercise of rights under that executed offset option so as to result in creation of an optioned transaction.

“Optioned transaction class” is similarly distinguished from “optioned transaction.” “Optioned transaction” refers to a contract or other transaction that is created between when an offset option is exercised. “Optioned transaction class” refers to a category of contracts or other transactions that have the same or similar terms. Notably, an optioned transaction class may refer to a class of transactions that are also traded outright. For example, an optioned transaction class may be a class of futures contracts that are also created and traded without any relationship to an offset option.

As explained in further detail below, offset options are options in which the strike price is unknown at the time of option execution. At the time of exercise, the strike price of an offset option is set at a level that is based on an offset from the market value of the optioned transaction as of the time of exercise, or as of some other time subsequent to option execution. An offset option is exercised upon the occurrence of one or more predefined external conditions. Those conditions are “external” in the sense that they require something other than a mere decision by an offset option holder and are beyond the control of offset option holders. Examples of conditions that could trigger exercise include, without limitation, weather-related events, market-related events and government-related events.

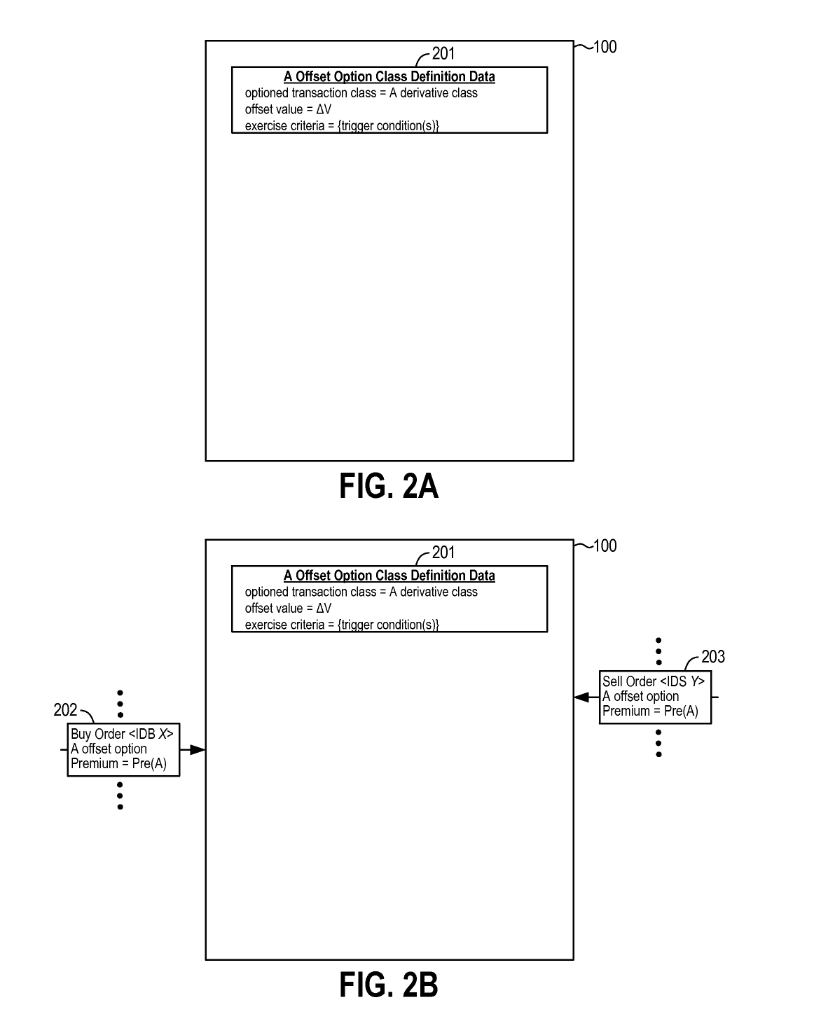

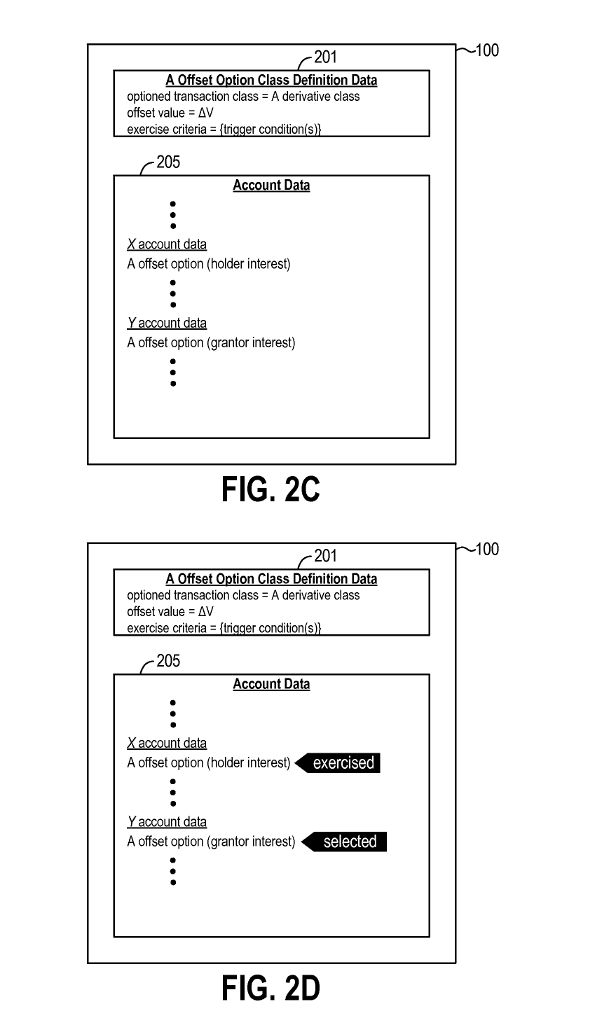

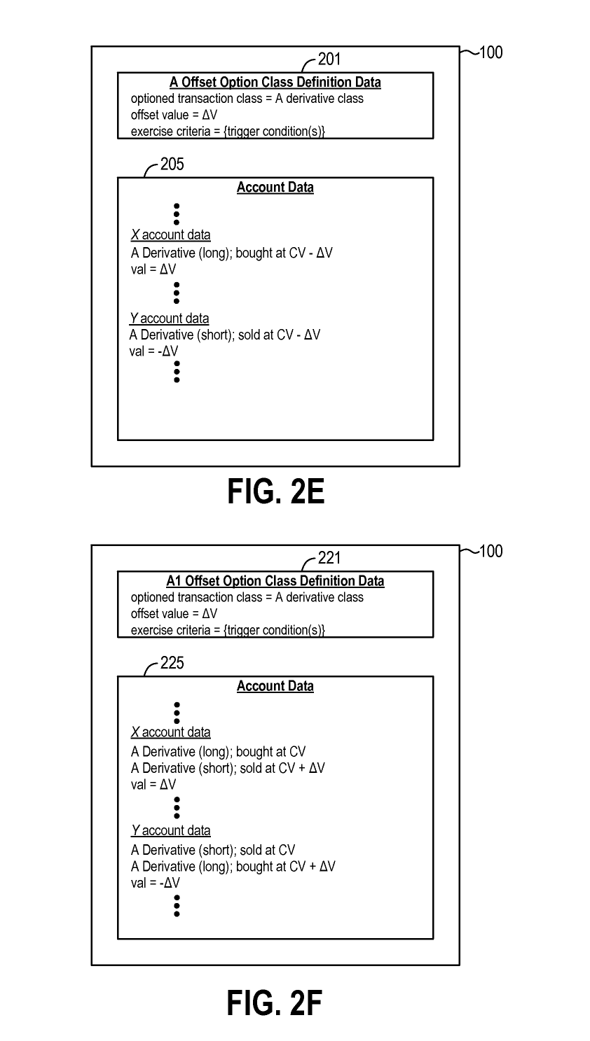

FIGS. 2A through 2F are block diagrams showing operations performed by exchange computer system 100 in connection with offset options according to at least some embodiments. Although the below description may refer to performance of operations by specific modules of system 100, in other embodiments one or more of such operations may be performed by different modules and/or by a computer system that is not an exchange computer system.

To simplify explanation, the operations of FIGS. 2A through 2F are described using a single hypothetical class of offset option. In particular, a hypothetical “A offset option” class is used for purposes of explanation. An executed offset option conforming to the A offset option class definition, i.e., an offset option contract between two parties that has the attributes specified by the A offset option class definition, will be referred to simply as an “A offset option.”

FIG. 2A shows operations performed by system 100 in connection with storing data defining the A offset option class. In particular, offset option module 142 stores A offset option class definition data 201. Included in data 201 is data indicating values for each of multiple parameters, with each of those parameters corresponding to a term applicable to all A offset options. System 100 may simultaneously create and store data defining numerous other offset option classes. System 100 may also perform operations, such as those described herein, with regard to offset options of those other classes while it is performing such operations with regard to A offset options.

The first parameter shown in FIG. 2A (“optioned transaction class”) has a value that identifies the type of optioned transaction in an A offset option. In particular, for every A offset option, the optioned transaction is a transaction of the identified class of transactions. In at least some embodiments, the optioned transaction class is a class of derivative contracts. For convenience, the optioned transaction class in the current example is a class of “A derivative” contracts. The value of the optioned transaction class parameter in data 201 could be, e.g., a pointer to other data storing a definition of a transaction class applicable to transactions traded outright through system 100.

In some embodiments, the optioned transaction class may be a class of futures contracts that are traded outright through system 100. “Futures contract” is a generic term for certain types of financial products. Futures contracts may be standardized contracts that are established by and traded through an exchange. Among other things, a futures contract class definition may specify a particular subject matter, or “underlying,” for all futures contracts of the class. As but one example, an underlying may be an agricultural or other type commodity. In such a case, the futures contract class definition may further specify that each contract of the class requires delivery of a predefined amount of that commodity at a predefined future date. As yet another example, the underlying may be a currency, a market index, an interest rate or other economic subject matter. In such a case, the futures contract class definition may specify payment on a predefined date of an amount computed from the value of the underlying on some future date. As but a further example, the underlying for a futures contract class may be a weather index that is calculated based on weather conditions (e.g., hurricanes, snowfall, rainfall, temperature) that may occur during a particular time period in a particular region. In such a case, the futures contract class definition may specify payment on a predefined date of an amount computed from the value of the weather index on some future date.

There are two counterparties to a futures contract. A long counterparty (or “long”) usually refers to a futures contract party holding a long position, with that party also known as the buyer of the futures contract. For physically-settled futures contracts, a long may agree to pay a contract price in return for physical delivery of a contract underlying (e.g., a commodity) on a future date. A short counterparty (or “short”) usually refers to a futures contract party holding a short position, with that party also known as a seller of the futures contract. For physically-settled futures contracts, a short may agree to receive a contract price in return for providing physical delivery of the contract underlying on the future date.

Some types of futures contracts are financially settled at contract maturity by a payment. For example, a futures contract may have a deliverable that represents a payment at a future time, with that payment representing the value of some underlying. That underlying may be, e.g., a market index or some other type of index. When such a futures contract matures, accounts of the short and the long are adjusted so that a net difference between the futures contract price and the value of the underlying at contract maturity is either paid by the short to the long (if the underlying-based value exceeds the contract price) or paid by the long to the short (if the contract price exceeds the underlying-based value). Some types of financially settled futures contracts may be nominally structured as a contract in which the long pays a contract price in return for payment by the short of a value based on the underlying. In effect, however, such a contract is often an agreement in which the long agrees to receive the difference between the contract price and the underlying-based value if the underlying-based value exceeds the contract price and to pay that difference if the contract price exceeds the underlying-based value. A short in such a contract agrees to the opposite (i.e., to pay the difference between the contract price and the underlying-based value if the underlying-based value exceeds the contract price, to receive that difference if the contract price exceeds the underlying-based value).

Other types of financially settled futures contracts may be explicitly structured in this manner. For example, the contract price of a weather futures contract may be a value of a weather-related index. A long to such a contract may agree to receive a payment based on the difference between the contract price and the index value on a future date if the index value on that future date exceeds the contract price. The long also agrees to pay an amount based on the difference between the contract price and the index value on a future date if the contract price exceeds the index value on that date. The amount paid or received may be, e.g., calculated as a certain dollar value times the difference between the contract price and index value. A short to such a contract may agree to the opposite (pay amount based on positive difference between index value and contract price or receive cash amount based on negative difference between index value and contract price).

Futures contracts may be traded multilaterally through an exchange. For example, parties wishing to buy futures contracts of a particular class may submit “bid” or “buy” orders to the exchange that identify that futures contract class and that specify contract prices the buy order submitters are willing to accept. Parties wishing to sell futures contracts of that class may submit “offer” or “sell” orders to the exchange that identify that futures contract class and that specify contract prices those parties are willing to accept. The exchange may then match buy and sell orders based on contract prices in the orders and create contracts for those matched buy and sell orders. The parties that submitted those matched orders become counterparties to the resulting contracts. The exchange may also store data indicating the resulting long and short contract interests of those counterparties.

For each multi-laterally traded futures contract, there is a long counterparty and a short counterparty. Generally, however, either the long or the short of each futures contract is a clearinghouse. For example, a first counterparty may offer to sell a particular type of futures contract through an exchange. A second counterparty may bid to buy a futures contract of that type at the offered price. Upon matching the offer order and the bid order, the exchange may then establish a first contract in which the first counterparty is the short and the clearinghouse is the long, and a second contract in which the second counterparty is the long and the clearinghouse is the short, with the contract price of the first and second contracts being the same. To the clearinghouse, the first and second contracts cancel one another. Assuming the first and second counterparties fulfill their contractual obligations, the net effect of the first and second contracts to the clearinghouse is a wash. To the first counterparty, satisfaction of long obligations under the first contract by the clearinghouse is equivalent to satisfaction of such obligations by the second counterparty. To the second counterparty, satisfaction of short obligations under the second contract by the clearinghouse is similarly equivalent to satisfaction of such obligations by the first counterparty. However, the first and second counterparties benefit because the clearinghouse assumes the risk of counterparty default.

An exchange may also track the values of futures contracts after they have been created, and may periodically adjust accounts of the counterparties to those contracts based on changes in contract values. For example, the first counterparty in the preceding example may have agreed to accept a contract price P and the second party may have agreed to pay a contract price P. On a subsequent trading day, the closing price for futures contracts of that same type may have increased by ΔP. If the first party were to liquidate its position by purchasing a contract at that closing price to obtain a long position, the first party would realize a loss based on ΔP. Conversely, if the second party were to liquidate its position by selling a contract at that closing price to obtain a short position, the second party would realize a gain based on ΔP. The situation would be reversed if, on the subsequent trading day, the closing price for futures contracts of that same type had decreased by ΔP.

As also shown in FIG. 2A, offset option A class definition data 201 further includes data defining a value for an offset value parameter. That defined value, shown generically for convenience as “ΔV,” represents an offset from a future market value of transactions of the optioned transaction class. As explained in more detail below, that offset value and the future market value will be used when assigning values to positions that result from exercise of an offset option. The offset value could be defined in absolute or relative terms. If defined in absolute terms, the offset value may be a specific quantity of the units in which optioned transactions of the option transactions are traded. For some types of optioned transactions, this may be a specific amount of a specific currency. For other types of optioned transactions, this may be a specific number of index points, a specific number of basis points, or a specific quantity of some other unit. If defined in relative terms, the offset value could be defined as one or more formulas or algorithms for calculating an offset value based on one or more other values defined in data 201 or elsewhere.

Class definition data 201 also includes data defining criteria for exercise of an A offset option. Those criteria comprise one or more conditions that, upon occurrence, will trigger the exercise of an A offset option. For convenience, these conditions are shown generically in FIG. 2A as “{trigger condition(s)}”. In at least some embodiments, trigger conditions are one or more external conditions that are beyond the control of parties that may buy A offset options. If the A derivative class is a class of weather futures contracts, for example, the trigger conditions may include a threshold set of relevant weather conditions over a certain time in a certain area. If the A derivative class is a class of market index futures contracts, the trigger conditions may include a predefined market index value or some other significant economic condition (e.g., a government employment report indicating unemployment above a certain level).

Although not shown in FIG. 2A, data 201 could include data defining additional parameters that correspond to terms applicable to A offset options. For example, data 201 may include data specifying whether an A offset option is structured as a put option, a call option or a combination put/call option (as described below). As another example, data 201 may also include data specifying an expiration date after which occurrence of the trigger conditions will not result in exercise. As a further example, data 201 may include data indicating whether orders for A offset options should specify a premium in absolute or relative terms. An order specifying a bid premium in absolute terms could include data expressly indicating a specific value that the ordering party will pay; an order specifying an offer premium in absolute terms could include data expressly indicating a specific value that the ordering party will accept. An order specifying a bid or offer premium in relative terms could include data indicating a percentage of, or some incremental amount relative to, some reference value. That reference value could be based on, e.g., the offset value defined by data 201.

FIG. 2B shows operations performed by system 100 in connection with receipt of orders for offset options conforming to the A offset option class definition. A first party (“X”) submits buy order data 202 corresponding to a buy order for an A offset option. Data 202 indicates the class of offset option that party X wishes to buy (“A offset option”) and a bid value for a premium (shown generically as “Pre(A)”) that party X is willing to pay for receiving an offset option of the indicated class. Data 202 may further include an identifier of party X (“<IDB X>”). As indicated by the vertical ellipses above and below data 202, additional buy order data corresponding to other buy orders for A offset options may be submitted by party X and/or by other parties. That other buy order data may indicate premium bid values that are the same as or different from that indicated by data 202. A second party (“Y”) submits sell order data 203 corresponding to a sell order for an A offset option. Data 203 indicates the class of offset option that party Y wishes to sell (“A offset option”) and an offer value for a premium (also shown generically as “Pre(A)”) that party Y is willing to accept for granting an offset option of the indicated class. Data 203 may further include an identifier of party Y (“<IDS Y>”). As indicated by the vertical ellipses above and below data 203, additional sell order data corresponding to other sell orders for A offset options may be submitted by party Y and/or by other parties. That other sell order data may indicate premium offer values that are the same as or different from that indicated by data 203.

FIG. 2C shows operations performed by system 100 after receipt of buy order data 202 and sell order data 203. System 100 (e.g., match engine module 106) has matched the buy order corresponding to data 202 with the sell order corresponding to data 203 based on the premium bid and offer values (Pre(A), Pre(A)) indicated by data 202 and data 203. In some embodiments, system 100 may perform such matching anonymously and neither party X nor party Y knows the identity of the other.

As shown in FIG. 2C, system 100 (e.g., account data module 104 and/or clearinghouse module 140) stores account data 205 that includes account data for party X and account data for party Y. The party X account data indicates that party X now has a holder interest in an A offset option. The party Y account data indicates that party Y now has a grantor interest in an A offset option. Although not shown in the drawings, the account data may further include data indicating a reduction of an X account cash balance by Pre(A) and a corresponding increase in a Y account cash balance by Pre(a). The vertical ellipses in FIG. 2C indicate that account data 205 could include additional account data for party X, party Y and/or other parties.

FIG. 2D shows operations performed by system 100 at the time when A offset options are exercised. Prior to the time represented in FIG. 2D, which time may be defined by class definition data 201, system 100 determines whether it has received data indicating satisfaction of the A offset option class exercise criteria. For example, system 100 may regularly receive periodic reporting data that includes values for an index, a market condition, a weather condition or some other subject matter relevant to the exercise criteria defined in data 201. At the post-execution time for determining if the A offset option class exercise criteria are met, system 100 may perform automated analysis of that reporting data to determine if threshold values for various measured quantities contained in the reporting data have been achieved. Upon determining that the exercise criteria have been satisfied, system 100 generates and stores data to indicate that executed A offset options are now exercised. As also shown in FIG. 2D, system 100 also stores data to indicate selection of A offset option grantor interests to satisfy to A offset option holder interests. In the example of FIG. 2D, the grantor interest of Y has been selected to satisfy the holder interest of X. Although the example of FIGS. 2A through 2F indicates that the interests of the parties (X and Y) whose A offset option orders were matched are again paired at time of exercise, this need not be the case. For example, an A offset grantor interest held by a party Z (not shown) could alternately be selected to satisfy the holder interest of X and the interest of Y could alternately be selected to satisfy an A offset option holder interest of a party W (not shown).

FIG. 2E shows operations performed by system 100 at or just after the time when A offset options are exercised. In response to the data indicating exercise of A offset options and selection of Y's A offset option grantor interest, system 100 stores data indicating a long position of X in an A derivative and a short position of Y in an A derivative. System 100 further determines a current value CV for A derivatives. System 100 makes that determination at the time of exercise or at some other post-execution time so that the value CV would have been unknown prior to A offset option execution. That value CV may be, e.g., a most recent closing value for outright trades in A derivatives as of the time of A offset option exercise. If ΔV is defined in relative terms (e.g., as a formula) by data 201, system 100 also calculates ΔV. System 100 then stores data indicating a positive net value increase of ΔV for X's account associated with the A derivative long position. Because this net value increase is equivalent to a value of an A derivative that was purchased for a price of CV−ΔV, system 100 may further (or alternatively) store account data for X indicating a purchase of the A derivative for CV−ΔV. System 100 also assigns a negative net value decrease of −ΔV for Y's account associated with the A derivative short position. Because this net value decrease is equivalent to a value of an A derivative that was sold for a price of CV−ΔV, system 100 may further (or alternatively) store account data for Y indicating a sale of the A derivative for CV−ΔV.

In some embodiments, data 201 may indicate that all A offset options are exercised in advance of the maturity date of A derivatives. In such an embodiment, X may liquidate its A derivative long position by acquiring an A derivative short position at CV and thereby realize a gain of ΔV. Similarly, Y may liquidate its A derivative short position by acquiring an A derivative long position at CV and thereby limit its loss to ΔV. In some embodiments, data 201 may indicate that all A offset options are exercised on the maturity date of A derivatives. In some such embodiments, if an A derivative is a financially settled derivative, system 100 may perform further operations to automatically store account data for X that indicates final settlement of the A derivative long position and an increase in X's account cash balance by ΔV, and to automatically store account data for Y that indicates final settlement of the A derivative short position and a reduction in Y's account cash balance by ΔV.

In the example of FIGS. 2A through 2E, A offset options are structured as call options. In particular, class definition data 201 contains data that indicates the holder of an exercised A offset option acquires a long interest in an optioned transaction. In some embodiments, offset options may be structured as put options. In such an embodiment, definition data for an offset option class may include data that indicates a holder of an exercised offset option acquires a short interest in an optioned transaction. If A offset options were structured in such a manner, for example, system 100 may alternatively store data associated with the account of X indicating a positive net value increase of ΔV for X's account and an A derivative sold for a price of CV+ΔV. In such an embodiment, system 100 may also store data associated with the account of Y indicating a negative net value increase of −ΔV for Y's account and an A derivative purchased for a price of CV+ΔV.

In some embodiments, offset options may be structured as combination put/call options. FIG. 2F shows operations performed by system 100 in connection with such an embodiment at or shortly after exercise. As shown in FIG. 2F, system 100 has stored data 221 that includes data defining an A1 offset option class. Data 221 may be similar to data 201 and may define the A derivative class as the optioned transaction class, may define the same offset value ΔV defined by data 201, may define the same exercise criteria defined by data 201, etc., such that A1 offset options are traded, executed and exercised in a manner similar to that described for A offset options. Unlike A offset options, however, A1 options are structured as combination put/call options. In particular, data 221 includes data indicating that, on exercise of A1 offset options, the owner of a holder interest receives a set of A derivative positions that includes an A derivative long position purchased at CV and an A derivative short position sold at CV+ΔV, with the net value of those positions being ΔV. As shown in FIG. 2F, system 100 has stored data for X in account data 225 indicating an A derivative long position purchased at CV, an A derivative short position sold at CV+ΔV, and a positive net value of ΔV for those positions. Data 221 further includes data indicating that, on selection of an A1 offset option grantor interest to satisfy a holder interest, the owner of that selected interest receives a set of A derivative positions that includes an A derivative short position sold at CV and an A derivative long position bought at CV+ΔV, with a net value of those positions being −ΔV. As further shown in FIG. 2F, system 100 has stored data for Y in account data 225 indicating an A derivative short position sold at CV and an A derivative long position bought at CV+ΔV, resulting in a net value of those A derivative positions of −ΔV.

In the examples described thus far, a generic “A derivative class” was used for purposes of example. In at least some embodiments, and as also described above, the A derivative class may be a class of futures contracts that are traded outright through an exchange that operates computer system 100. Indeed, such futures contracts may also be separately traded outright through system 100. Classes of futures contracts which could serve as the optioned transaction class for an offset transaction class according to various embodiments include numerous classes of financially settled and physically settled futures contracts. Examples of financially settled futures contract classes which could serve as an optioned transaction class include, but are not limited to, a futures contract in which the underlying is an equity index, a futures contract in which the underlying is an interest rate or difference between interest rates, a futures contract in which the underlying is a foreign currency, and a futures contract in which the underlying is a weather-related index. Examples of physically settled futures contract classes which could serve as the optioned transaction class include, but are not limited to, a futures contracts where the underlying is an agricultural commodity (e.g., a grain, an oil seed, a type of livestock or livestock product, a dairy product, timber or other forest product), a futures contract where the underlying is an energy commodity (e.g., petroleum, a refined petroleum product, natural gas, coal, electrical energy), and a futures contract where the underlying is a metal product (e.g., a base, industrial or precious metal, a metal ore).

An optioned transaction class need not be a futures contract, however. In some embodiments, for example, an optioned transaction class may be a class of forward contracts or a class of some other type of over-the-counter (OTC) contracts. In some such embodiments, offset option class definition data may further include additional data that specifies minimum requirements of OTC contracts of the optioned transaction class.

As also indicated above, numerous types of exercise criteria can be defined for a class of offset options. In at least some embodiments, the exercise criteria are at least partially related to the optioned transaction class. In some embodiments, the optioned transaction class may be a class of weather futures contracts in which the underlying is an index calculated from rainfall amounts in designated regions over one or more designated time periods. If the offset option is intended for exercise if a drought occurs, a related set of exercise criteria could include a total rainfall amount in one or more of those designated regions (and or in other regions) not exceeding a certain value over a particular period of time. Alternatively, if the offset option is intended for exercise if flooding occurs, a related set of exercise criteria could include a total rainfall amount in one or more regions exceeding a certain value over a particular period of time. In some embodiments, the optioned transaction class may be a class of futures contracts where the underlying is a published market index such as the S&P 500, the NASDAQ 100, the Nikkei 225, the Dow-Jones industrial average, etc. In some such embodiments, related set of exercise criteria could include the occurrence of a significant economic event as defined by the exercise criteria. For example, the exercise criteria could define a set of financial default conditions and specify one or more entities (e.g., governments, financial institutions or corporations) and indicate that a financial default by some subset of the entities is a trigger condition. In some embodiments where the optioned transaction class has a published market index as an underlying, the exercise criteria could define the trigger condition based on a value of a different market index and/or on a value of some other published economic index (e.g., a published housing index, a published unemployment index).

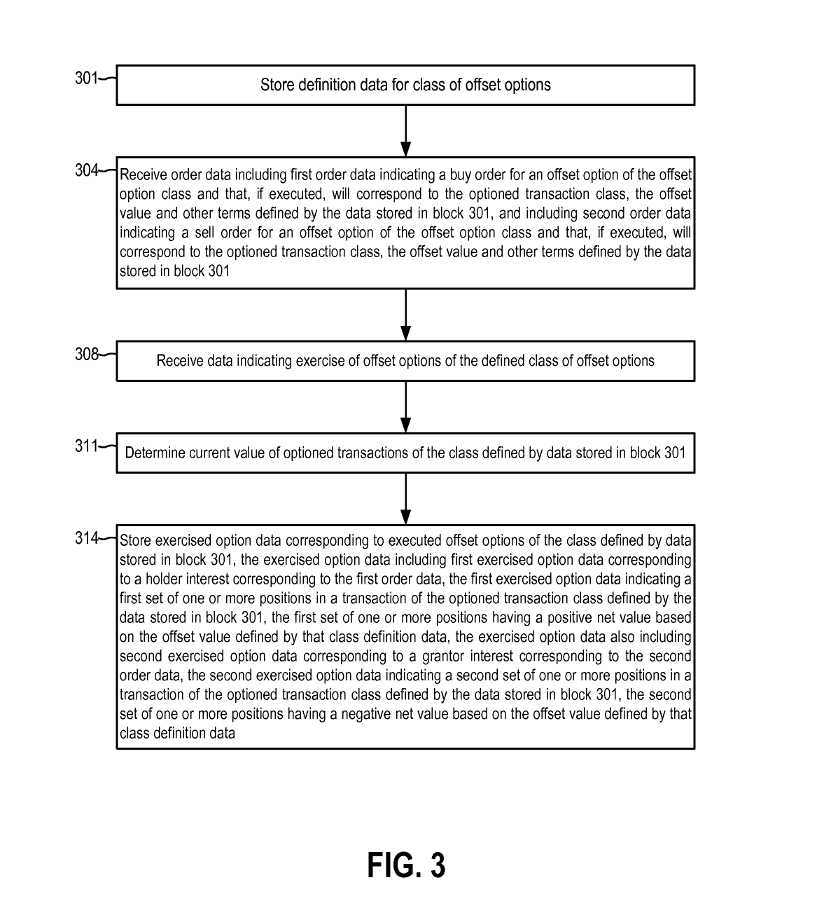

FIG. 3 is a flow chart showing operations performed in methods according to some embodiments. The flow chart of FIG. 3 encompasses various operations described in connection with FIGS. 2A through 2F, as well as operations performed in connection with other embodiments. In some embodiments, the operations of FIG. 3 are performed by exchange computer system 100. In other embodiments, the operations of FIG. 3 may be carried out by another type of computer system.

In block 301, a computer system stores offset option class definition data. That stored data may be data such as definition data 201 shown in FIGS. 2A-2E and/or definition data 221 shown in FIG. 2F. The stored offset option class definition data includes data that indicates a class of optioned transactions, data that indicates each offset option of the defined offset option class is exercisable into one or more positions in optioned transactions of the optioned transaction class, data indicating an offset value applicable to offset options of the defined offset option class, and data defining one or more exercise criteria applicable to offset options of the defined offset option class. The stored data may also include data defining values for one or more additional parameters that define terms applicable to offset options of the defined offset option class. Examples of such terms may include, without limitation, units of a strike price, how bid and offer values should be specified (e.g., in relative or absolute terms) and the manner in which a current value for an optioned transaction is determined.

In block 304, the computer system receives order data. That order data, which may be data such as data 202 and 203 shown in FIG. 2B, includes first order data indicating a buy order for an offset option of an offset option class and that, if executed, will correspond to the optioned transaction class, the offset value and other terms defined by the data stored in block 301. That order data also includes second order data indicating a sell order for an offset option of an offset option class and that, if executed, will also correspond to the optioned transaction class, the offset value and other terms defined by the data stored in block 301.

In block 308, the computer system receives data indicating exercise of offset options of the class defined by the definition data stored in block 301. The data received in block 308 may include data indicating satisfaction of the exercise criteria defined by that class definition data. The computer system may receive the data in block 308 in different ways in various embodiments. As but one example, the computer system could, at an exercise date defined by the class definition data, automatically analyze relevant index data for a current and/or one or more recent periods to determine if a threshold value has been exceeded. As another example, the computer system could, at the exercise date, automatically analyze relevant economic, weather or other type of statistical data for a current and/or one or more recent periods to determine if a threshold value for a specified measurement has been exceeded.

In block 311, the computer system determines a current value for optioned transactions of the optioned transaction class indicated by the class definition data stored in block 301. That current value is a value for a time after execution of offset options of the class defined by the data stored in block 301. In some embodiments, the computer system may make this determination by retrieving data indicating a closing price for outright trades of transactions of the optioned transaction class. That closing price may be, e.g., the most recent closing price prior to exercise of the offset options.

In block 314, the computer system stores exercised option data corresponding to executed offset options of the class defined by the definition data stored in block 301. That exercised option data also corresponds to orders that were matched to result in those executed offset options, including the first order data and the second order data described above in connection with block 304. In particular, the exercised option data includes first exercised option data that corresponds to a holder interest corresponding to the first order data. The first exercised option data indicates a first set of one or more positions in a transaction of the optioned transaction class defined by the class definition data stored in block 301, the first set of one or more positions having a positive net value based on the offset value defined by that class definition data. The exercised option data also includes second exercised option data that corresponds to a grantor interest corresponding to the second order data. The second exercised option data indicates a second set of one or more positions in a transaction of the optioned transaction class defined by the class definition data stored in block 301, the second set of one or more positions having a negative net value based on the offset value defined by that class definition data.

### Example

The following provides one illustrative and non-limiting example of an offset option according to some embodiments. Assume that it is desirable to create an offset option that provides for a fixed payment if a hurricane occurs in some specified geographic area on or before a specified expiration date for the offset option. Assume further that there is an available hurricane futures contract that is cash settled by reference to an index that tracks weather conditions, e.g., by reference to maximum wind speeds observed on or before a fixed expiration date in the region of interest. Examples of such a hurricane futures contract include the various classes of hurricane futures contracts traded through the Chicago Mercantile Exchange, which futures are based on a weather index known as the CME Hurricane Index™ (“CHI”).

In this example, a hurricane is deemed to have occurred if the CHI or some other index tracking wind speeds rises above a specified level. This is to distinguish a hurricane from a less severe weather event. If a hurricane is deemed to have occurred, the offset option becomes exercisable on an automatic basis.

At that point, one may book a long position in the hurricane futures contract at a value that is $ΔV below a current value CV of the hurricane futures contract on behalf of a buyer of the offset option. A short position in the hurricane futures contract is also booked, at a value that is $ΔV below the current value CV of the hurricane futures contract, on behalf of the seller of the offset option. The positions may subsequently be liquidated by the long or short at current market values, thus resulting in a profit for the long and a loss by the short equal to the span or offset between the booked value and the current value CV.

### CONCLUSION

The foregoing description of embodiments has been presented for purposes of illustration and description. The foregoing description is not intended to be exhaustive or to limit embodiments to the precise form explicitly described or mentioned herein. Modifications and variations are possible in light of the above teachings or may be acquired from practice of various embodiments. The embodiments discussed herein were chosen and described in order to explain the principles and the nature of various embodiments and their practical application to enable one skilled in the art to make and use these and other embodiments with various modifications as are suited to the particular use contemplated. Any and all permutations of features from above-described embodiments are the within the scope of the invention.

1. A method comprising:
receiving first and second order data at a computer system, the first order data indicating a buy order for an offset option of an offset option class and the second order data indicating a sell order for an offset option of the offset option class, wherein all options of the offset option class correspond to an optioned transaction class and to an offset value;
storing first and second execution data by the computer system, the first execution data corresponding to the buy order and indicating a holder interest in an offset option of the offset option class, the second execution data corresponding to the sell order and indicating a grantor interest in an offset option of the offset option class;
determining, by the computer system at a time after the storing of the first and second execution data, a current value for a transaction of the optioned transaction class; and
storing first and second exercised option data by the computer system in response to data indicating exercise of offset options of the offset option class, wherein
the first exercised option data corresponds to the holder interest and indicates a first set of one or more positions in a transaction of the optioned transaction class, the first set of one or more positions having a positive net value based on the offset value, and
the second exercised option data corresponds to the grantor interest and indicates a second set of one or more positions in a transaction of the optioned transaction class, the second set of one or more positions having a negative net value based on the offset value.

2. The method of claim 1, wherein all options of the offset option class correspond to a common exercise trigger condition, and wherein the data indicating exercise of offset options of the offset option class includes data indicating occurrence of the exercise trigger condition.

3. The method of claim 2, wherein the exercise trigger condition comprises a weather event.

4. The method of claim 2, wherein the exercise trigger condition comprises a market-related event.

5. The method of claim 2, wherein the exercise trigger condition comprises a governmental event.

6. The method of claim 1, wherein the first set of one or more positions is a position in a single transaction of the optioned transaction class.

7. The method of claim 1, wherein the first set of one or more positions comprises a long position in a first transaction of the optioned transaction class and a short position in a second transaction of the optioned transaction class.

8. One or more non-transitory computer-readable media storing computer executable instructions that, when executed, cause a computer system to perform operations that include:
receiving first and second order data, the first order data indicating a buy order for an offset option of an offset option class and the second order data indicating a sell order for an offset option of the offset option class, wherein all options of the offset option class correspond to an optioned transaction class and to an offset value;
storing first and second execution data, the first execution data corresponding to the buy order and indicating a holder interest in an offset option of the offset option class, the second execution data corresponding to the sell order and indicating a grantor interest in an offset option of the offset option class;
determining, at a time after the storing of the first and second execution data, a current value for a transaction of the optioned transaction class; and
storing first and second exercised option data in response to data indicating exercise of offset options of the offset option class, wherein
the first exercised option data corresponds to the holder interest and indicates a first set of one or more positions in a transaction of the optioned transaction class, the first set of one or more positions having a positive net value based on the offset value, and
the second exercised option data corresponds to the grantor interest and indicates a second set of one or more positions in a transaction of the optioned transaction class, the second set of one or more positions having a negative net value based on the offset value.

9. The one or more non-transitory computer-readable media of claim 8, wherein all options of the offset option class correspond to a common exercise trigger condition, and wherein the data indicating exercise of offset options of the offset option class includes data indicating occurrence of the exercise trigger condition.

10. The one or more non-transitory computer-readable media of claim 9, wherein the exercise trigger condition comprises a weather event.

11. The one or more non-transitory computer-readable media of claim 9, wherein the exercise trigger condition comprises a market-related event.

12. The one or more non-transitory computer-readable media of claim 9, wherein the exercise trigger condition comprises a governmental event.

13. The one or more non-transitory computer-readable media of claim 8, wherein the first set of one or more positions is a position in a single transaction of the optioned transaction class.

14. The one or more non-transitory computer-readable media of claim 8, wherein the first set of one or more positions comprises a long position in a first transaction of the optioned transaction class and a short position in a second transaction of the optioned transaction class.

15. A computer system comprising:
at least one processor; and
at least one non-transitory memory, wherein the at least one non-transitory memory stores instructions that, when executed, cause the computer system to perform operations that include
receiving first and second order data, the first order data indicating a buy order for an offset option of an offset option class and the second order data indicating a sell order for an offset option of the offset option class, wherein all options of the offset option class correspond to an optioned transaction class and to an offset value,
storing first and second execution data, the first execution data corresponding to the buy order and indicating a holder interest in an offset option of the offset option class, the second execution data corresponding to the sell order and indicating a grantor interest in an offset option of the offset option class,
determining, at a time after the storing of the first and second execution data, a current value for a transaction of the optioned transaction class, and
storing first and second exercised option data in response to data indicating exercise of offset options of the offset option class, wherein
the first exercised option data corresponds to the holder interest and indicates a first set of one or more positions in a transaction of the optioned transaction class, the first set of one or more positions having a positive net value based on the offset value, and
the second exercised option data corresponds to the grantor interest and indicates a second set of one or more positions in a transaction of the optioned transaction class, the second set of one or more positions having a negative net value based on the offset value.

16. The computer system of claim 15, wherein all options of the offset option class correspond to a common exercise trigger condition, and wherein the data indicating exercise of offset options of the offset option class includes data indicating occurrence of the exercise trigger condition.

17. The computer system of claim 16, wherein the exercise trigger condition comprises a weather event.

18. The computer system of claim 16, wherein the exercise trigger condition comprises a market-related event.

19. The computer system of claim 16, wherein the exercise trigger condition comprises a governmental event.

20. The computer system of claim 15, wherein the first set of one or more positions is a position in a single transaction of the optioned transaction class.

21. The computer system of claim 15, wherein the first set of one or more positions comprises a long position in a first transaction of the optioned transaction class and a short position in a second transaction of the optioned transaction class.
